(19) United States
(12) Patent Application Publication
(10) Pub. No.: US 2011/0209159 A1
(43) Pub. Date: Aug. 25, 2011

(54) CONTEXTUAL CORRELATION ENGINE

(75) Inventors: Alan Baratz, Los Altos Hills, CA (US); George Paolini, Carmel, CA (US); Christian von Reventlow, Gladstone, NJ (US)

(73) Assignee: Avaya Inc., Basking Ridge, NJ (US)

(21) Appl. No.: 12/837,919

(22) Filed: Jul. 16, 2010

Related U.S. Application Data
(60) Provisional application No. 61/306,694, filed on Feb. 22, 2010.

(51) Int. Cl. G06F 9/46; G06F 17/30; G06F 17/00

(52) U.S. Cl. 718/108; 707/709; 715/205; 707/770; 707/E17.112; 707/E17.108

(57) ABSTRACT

Embodiments of the present invention are directed to a communication system that provides various automated operations, including linking applications and metadata across computational devices, using a stimulus to automatically find and launch associative and/or contextual materials and/or information required to conduct a work session without manually having to locate and launch each of these materials and/or information, and, by monitoring user behavior, creating and maintaining tokens defining the state of an instance of a workflow for later workflow resumption.

### CROSS REFERENCE TO RELATED APPLICATION

The present application claims the benefits of U.S. Provisional Application Ser. Nos. 61/306,694, filed Feb. 22, 2010, which is incorporated herein by this reference in its entirety.

### FIELD

The invention relates generally to communications and particularly to intelligent telecommunication systems.

### BACKGROUND

When a user of a computing and/or telecommunications device is preparing for a work session, that user usually needs to open one or more files, documents, applications, blogs, micro-blogs, sharepoints, and/or web links to conduct the work session. This is true whether the work session is made up of the work product of a single user or whether it is either a real-time or off-line collaboration among two or more individuals. While organized file folders and document naming conventions are known, the materials required for a work session may be distributed between folders, devices, applications, and the like. This means that the user must locate the relevant materials needed to prepare for a work session. This is made more difficult when the work session is a recurring event, especially one with a long time interval between occurrences where the user may not remember where all of the materials are located and what they were named. Another complication is that, with the rate of change of technology, the device, application, or file for a work session may be lost or past versions may be unavailable as the user transitions to new versions or replacement devices, applications, or file formats. As a result, when taken across all of the user's devices, applications, and files, management of the information for work sessions becomes a daunting task.

There are many systems that attempt to make locating materials easier.

For example, the Explore™ capability within Microsoft's Windows™ allows the user to conduct keyword searches to attempt to locate materials by name and/or keyword.

Another mechanism is the date, time, and name information for files such that a specific version can be located.

Within web technology, such as WebML™, a user can set up contextual hypertext links. According to Wikipedia, there are macroscopic and microscopic views of such contextual hypertext links. In “Hypertext Design in the large” the web application architect defines the structure “in the large” of the hypertext, by identifying pages and units, linking them, and mapping units to the main entries and relationships of the structure schema. In this way, he develops a “skeleton” site view and then interatively improves it. In “Hypertext Design in the small”, the web application architect concentrates next in the design “in the small” of the hypertext, by considering each page and unit individually. At this stage, he may add non-contextual links between pages, consolidate the attributes that should be included within a unit, and introduce novel pages or units for special requirements (e.g., alternative index pages to locate objects, filters to search the desired information, and so on). These WebML™ structures are pre-defined, fixed, contextual, and hyperlinked structures. These links do not automatically adapt to change and require a web architect or designer to make modifications in the structures as the web page(s) are changed.

There are machine learning, fuzzy logic, and/or Artificial Intelligence (“AI”) models that attempt to act like a human intelligence for a specific range of tasks. This includes contextually tied information or other associative file management systems.

There remains a need for a workflow management system that makes documents, communications, related applications, and the like easier to find and launch.

### SUMMARY

These and other needs are addressed by the various embodiments and configurations of the present invention. The present invention is directed generally to an intelligent communication system that monitors user actions and performs various operations responsive to the monitored actions.

In a first embodiment, a system and method are provided that perform the following operations:
(a) retrieving, as part of a current and/or future instance of a noncommunication workflow, a token, the token comprising a reference to information associated with the current and/or future instance of the workflow and being based on a prior instance of the workflow;
(b) retrieving, using the at least one reference, the information associated with the current and/or future instance of the workflow; and
(c) displaying, on a communication node of the user, the retrieved information.

In a second embodiment, a system and method are provided that perform the following operations:
(a) monitoring, during an instance of a workflow, a behavior of a user and/or interaction of the user with a selected computational device to determine an association between the workflow information accessed during the workflow and/or a context of the user; and
(b) updating a token associated with the workflow to reflect the association between the workflow information accessed during the workflow and/or context of the user, whereby the token describes a state of the workflow at a particular point in time.

The various embodiments can have advantages. By way of example, the embodiments can, by using tokens, permit a user to quickly and conveniently locate and launch relevant workflow materials, even in complex heterogeneous network, in advance of a recurring or non-recurring workflow. The embodiments can use observations of past user behavior, manually placed tokens, machine learning, and the like to improve the ability to make correct decisions regarding launching workflow materials. In one configuration, the decisions are based on predicted or discerned patterns exhibited by the user, which can make a system more robust and accurate with less input from the user over time. In another configuration, the system monitors user behavior and offers token-generation suggestions to the user using a correlation algorithm. Such an algorithm allows the embodiments to cross a boundary of traditional information technology and computing and telecommunications to be able to contextually link related communication topics, applications, documents, files, sharepoints, web pages, blogs, micro-blogs, Really Simply Syndicated (“RSS”) feeds, and the like. Because the tokens are transportable, the embodiments can use tokens to “hot synchronize” devices so that they are up-to-date relative to one another.

These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “application”, “application program”, and “software application” refer to software that is used for business or entertainment. The terms refer to virtually any type of program, including spreadsheets such as Excel™, word processors such as Word™, communication modules such as Avaya Softphone™, instant messaging platforms, and e-mail platforms, personal information managers, media players such as iTunes™, Web browsers such as Internet Explorer™, and virtual reality games such as Second Life™. However, the term generally excludes essential control software such as the operating system.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “call log” refers to a collection, or list, of inbound and/or outbound calls. A call is typically described by timestamp (e.g., date and time of day of call set up, termination, or receipt), call duration, called number, calling number, callee identity, and/or caller identity.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The term “contact” refers to any voice, text, and/or video electronic communication, such as a voice call, E-mail, instant message, text chat, VoIP call, and the like.

The term “customer” or “client” denotes a party patronizing, serviced by, or otherwise doing business with the enterprise

The terms “determine”, “calculate” and “compute,” and variations thereof, as used herein, are used interchangeably and include any type of methodology, process, mathematical operation or technique.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

The term “engine” refers to a program that performs a core or essential function for other programs. It is also used to describe a special-purpose program containing an algorithm that can sometimes be changed. For example, an engine can be a central or focal program in an operating system, subsystem, or application program that coordinates the overall operation of other programs. The best known usage is the term “search engine,” which uses an algorithm to search an index of topics given a search argument. A search engine is designed so that its approach to searching the index can be changed to reflect new rules for finding and prioritizing matches in the index. In artificial intelligence, the program that uses rules of logic to derive output from a knowledge base is called an “inference engine.”

The term “hyperlink” refers to a reference to a document that the reader can directly follow, or that is followed automatically. The reference points to a whole document or to a specific element within a document. Hypertext is text with hyperlinks.

Such text is usually viewed with a computer. A hyperlink has an anchor, which is a location within a document from which the hyperlink can be followed; that document is known as its source document. The target of a hyperlink is the document, or location within a document, that the hyperlink leads to. The user can follow the link when its anchor is shown by activating it. Following has the effect of displaying its target, often with its context. In some hypertext, hyperlinks can be bidirectional; that is, they can be followed in two directions, so both points act as anchors and as targets. More complex arrangements exist, such as many-to-many links.

The terms “instant message” and “instant messaging” refer to a form of real-time text communication between two or more people, typically based on typed text. The instant message is conveyed by an instant messaging program offered by a service, such as AOL™, MSN Messenger™, Yahoo! Messenger™, Live Messenger™, and Apple's iChat™. Generally included in the instant messaging software is the ability to see the presence of another party; that is, the ability to see whether a chosen friend, co-worker or other selected person (known as a “buddy”) is online and connected through the selected service. Instant messaging differs from ordinary e-mail in the immediacy of the message exchange and also makes a continued exchange simpler than sending e-mail back and forth. Instant messaging, unlike e-mail, is also generally stateless. Most exchanges are text-only, though some services now allow voice messaging, file sharing and even video chat (when both users have cameras). For instant messaging to work, both users must be online at the same time and the intended recipient must be willing to accept instant messages. An attempt to send an instant message to someone who is not online (or is offline), or who is not willing to accept instant messages, will result in a notification that the transmission cannot be completed. If the online software is set to accept instant messages, it alerts the recipient with a distinctive sound and provides a window that collectively indicates that an instant message has arrived. The window allows the recipient to accept or reject the incoming instant message. An instant message session is deemed to disconnect, or be disconnected, when the user goes offline, refuses to accept an instant message, or is suspended by the user failing to respond to an instant message after a predetermined period of time after an instant message is sent and/or received. An instant message session is deemed to be reconnected (or a call-back deemed to occur) when the user resumes the instant messaging session, such as by responding to an outstanding instant message.

The term “link” refers to a reference from one location to another location. The location can, for example, be an electronic address, a data storage address, a Universal Resource Locator, a Universal Resource Indicator, and the like. Common examples of links include hyperlinks.

The term “metaphor telephone” refers to a communication device that displays a metaphorical depiction of a selected object, such as a device capability, a communication medium, a virtual or geographic location, and the like. An example is where a communication device richly displays a conference by each participating node's communication capabilities and limitations.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The term “presence information” refers to any information associated with a network node and/or endpoint device, such as a communication device, that is in turn associated with a person or identity. Presence information can indicate user status (e.g., online or offline), user availability (e.g., available, busy, on the phone, or out to lunch), user's desired contact means (e.g., instant messaging, circuit-switched telephone, packet-switched telephone, cell phone, pager, etc.) that may vary by contactor identity and/or contact time, and at what endpoint a contactor is most likely to reach successfully the presence service subscriber. Presence information can span a number of different communication channels. The aggregated view of a user's presence (that is, the availability across all of an individual's SIP-enabled devices) is called Multiple Points of Presence or MPOP. Examples of information useful in determining a user's presence and availability include information regarding the accessibility of the endpoint device, the recency of use of the endpoint device by the person, recency of authentication by the person to a network component, recency of registration of an endpoint device, an endpoint publishing presence information, SUBSCRIPTION requests generated by a user agent in the user's endpoint device, geographical location of the user using mobile device location information, scheduled activities on the user's calendar, indications whether or not a user has been reading or sending email, and an indication whether the user's email application has an out of office setting. Present information can be, for example, the electronic address of a device at which the service subscriber is currently deemed to be present and/or available.

The terms “online community”, “e-community”, or “virtual community” mean a group of people that primarily interact via a computer network, rather than face to face, for social, professional, educational or other purposes. The interaction can use a variety of media formats, including wikis, blogs, chat rooms, Internet forums, instant messaging, email, and other forms of electronic media. Many media formats are used in social software separately or in combination, including text-based chatrooms and forums that use voice, video text or avatars.

The term “Service Oriented Architecture” or “SOA” refers to a collection of services. These services communicate with each other. The communication can involve either simple data passing and/or two or more services coordinating some activity.

The term “social network service” is a service provider that builds online communities of people, who share interests and/or activities, or who are interested in exploring the interests and activities of others. Most social network services are web-based and provide a variety of ways for users to interact, such as e-mail and instant messaging services.

The term “social network” refers to a web-based social network.

The term “synchronized” means, in the context of databases, maintaining selected fields in the records of one database temporally up to date with respect to changes in the information stored, by the other database, in the selected or equivalent fields.

The term “token” refers to a container of information that can be transmitted between computational nodes and/or can be associated with a set of information, such as a document, communication, file, link, application, sharepoint, blog, micro-blog, Really Simple Syndicated (“RSS”) feed, and the like.

The term “VoIP” refers to a family of transmission technologies for delivering packetized voice communications over IP networks such as the Internet or other packet-switched networks, rather than the public switched telephone network (PSTN). Other terms frequently encountered and synonymous with VoIP are IP telephony, Internet telephony, voice over broadband (VoBB), broadband telephony, and broadband phone. Common protocols for VoIP include H.323 and the Session Initiation Protocol.

A “workflow” refers to a sequence of connected steps. The term “workflow” is commonly used in computer programming to capture and develop human-to-machine interaction. It can be a depiction of a sequence of operations, declared as work of a person, a group of persons, an organization or staff, and/or one or more simple or complex mechanisms. Workflow may be seen as any abstraction of real work, segregated in workshare, work split, or other types of ordering. The flow refers to a document that is being transferred from one step to another. A “workflow” can also be a model to represent real work for further assessment, e.g., for describing a reliably repeatable sequence of operations. More abstractly, a workflow can be a pattern of activity enabled by a systematic organization of resources, defined roles and mass, energy and information flows, into a work process that can be documented and learned. Workflows are commonly designed to achieve processing intents of some sort, such as physical transformation, service provision, or information processing.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a network architecture according to an embodiment;

FIG. 2 depicts a token according to an embodiment;

FIGS. 3A-B depict a flow chart according to an embodiment; and

FIG. 4 depicts a flow chart according to an embodiment.

### DETAILED DESCRIPTION

The disclosure, in various embodiments, provides a system and method to perform a variety of operations discussed in more detail below. The embodiments relate to work flow preparation and contextual material linkage. One operation is to link applications, files, documents, web links, sharepoints, blogs, micro-blogs, communications, Really Simple Syndication (“RSS”) feed, and other such materials and information across computational devices, frequently in a complex enterprise communications setting. Another operation is to use party identity, calendar events, and/or other items and events as the stimulus to trigger a system and method that automatically finds and launches associative and/or contextual materials and/or information required to conduct a work session without manually having to locate and launch each of these materials and/or information. Another operation is to observe past user behavior, automatically and/or manually placed associative and/or contextual tokens, machine learning, and the like to improve the ability of a system to make the correct decisions regarding work flow materials. Another operation uses a new graphical communications metaphor terminal as a vehicle to launch the work flow preparation system.

The various embodiments and configurations in this disclosure will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any application in which it is desirable to collect and associate related and temporally changing multimedia information for presentation to a user.

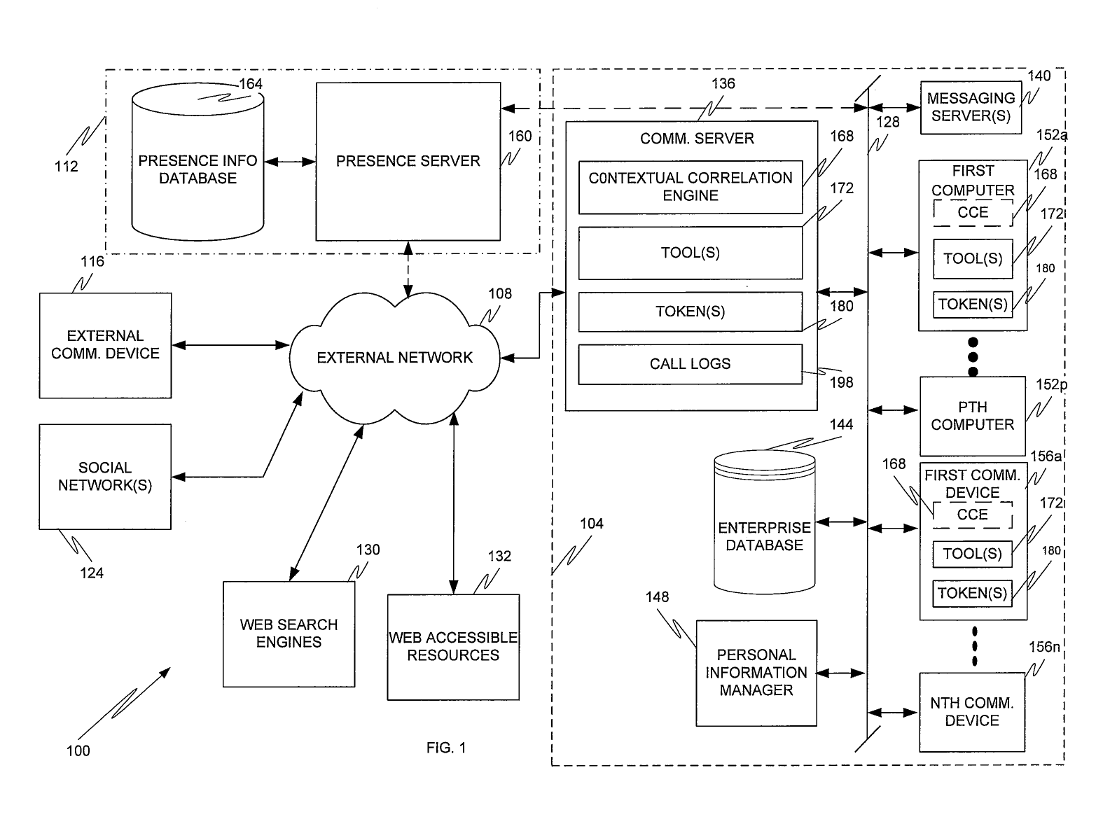

FIG. 1 depicts an architecture 100 according to an embodiment. Referring to FIG. 1, an enterprise network 104 is in communication, via external network 108, with a presence service 112, one or more external communication device(s) 116, a social network 124, web search engine(s) 130, and other web-accessible resources 132.

External network 108 can be any type of external network, including, without limitation, circuit or packet-switched, public and untrusted, private or VPN-based, etc. The external network 108 is preferably a public packet-switched and/or circuit-switched network or set of networks. In one configuration, the external network 108 is a public network supporting the TCP/IP suite of protocols.

The presence service 112 includes a presence server 160 and an associated presence information database 164 that may or may not be operated by (or be external to) the enterprise network 104. The presence server 160 and presence information database 164 collectively track the presence and/or availability of presence service subscribers and/or their communication devices and provide, to requesting entities, current presence information respecting selected presence service subscribers. As will be appreciated, when the presence service 112 is external to the enterprise the presence service subscribers are different from the enterprise subscribers.

The external communication device(s) 116 can be any suitable circuit- or packet-switched or digital (e.g., TDM-enabled) communication device. Examples include wired and wireless telephones, cellular phones, Personal Digital Assistants or PDAs, Personal Computers or PCs, laptops, packet-based H.320 video phones and conferencing units, packet-based voice messaging and response units, peer-to-peer based communication devices, metaphor telephones, and packet-based traditional computer telephony adjuncts.

The social network 124 can be any social internetworking service, including those defined above.

The web search engines 130 search for information on the external network 108, including information provided by web accessible resources 132. The information may consist of web pages, images, information and other types of files. Some search engines also mine data available in databases or open directories. Unlike web directories, which are maintained by human editors, search engines operate algorithmically or are a mixture of algorithmic and human input. Web engines typically operate through the sequential operations of web crawling, indexing, and searching. Exemplary search engines include Yahoo!™, Google™, Internet Explorer™, Bing™, Baidu™, AOL™, and Netscape™ search engines.

The web-accessible resources 132 refer to any indexed or otherwise searchable information or services available on the external network 108. Web-accessible resources 132 include information available on web pages, blogs, RSS feeds, and the like.

The enterprise network 104 includes a communications server 136, a (unified) messaging server 140, an enterprise database 144, a personal information manager 148, a plurality of first, second, . . . pth personal computers 152a-p, and a plurality of internal first, second, . . . nth communications devices 156a-n, interconnected by an (trusted or secure or private) internal network 128. The internal network 128 can be secured from intrusion by untrusted parties by a gateway (not shown) and/or firewall (not shown).

The communications server 136 can include a PBX, an enterprise switch, an enterprise server, or other type of telecommunications system switch or server. The communication server 136 is preferably configured to execute telecommunication applications such as the suite of MultiVantage™ or Aura™ applications of Avaya, Inc., including Communication Manager™, Aura Communication Manager™, Avaya IP Office™, and MultiVantage Express™.

The (unified) messaging server 140 may provide features for integrating real-time voice, video and text communication services, such as instant messaging, chat, telephony (including IP telephony), and video conferencing, with non real-time communication services, such as voice mail, e-mail, SMS, and fax.

The personal information manager 148 contains, organizes and/or synchronizes subscriber personal information, such as contact information or address books, electronic calendars, personal notes, lists (e.g., task lists), reminders, text message archives, RSS/Atom feeds, alerts, and project management. An exemplary personal information manager 148 is Outlook™ by Microsoft, Inc. An electronic calendar, as will be appreciated, includes scheduled events indexed by date and time.

The first, second, . . . pth computers 152a-p can be any computational device, with personal computers and laptops being illustrative.

The first, second, . . . nth communication devices 156a-n can be similar to the external communication devices 116. In some embodiments, the communication devices 156a-n may be IP-enabled, SIP-enabled, digital, and/or analog devices. Examples of suitable modified IP telephones include the 1600™, 2400™, 4600™, 5400™, 5600™, 9600™, 9620™, 9630™, 9640™, 9640G™, 9650™, and Quick Edition™ telephones, IP wireless telephones (such as Avaya Inc.'s IP DECT™ phones), video phones (such as Avaya Inc.'s Videphone™), metaphor phones, and softphones of Avaya, Inc. Other types of suitable communication devices 156a-n include, without limitation, cellular phones, analog phones, digital phones, etc.

In the ensuing discussion, “communication node” refers to any of the first . . . pth computers 152a-p and/or first . . . nth communication devices 156a-n.

The enterprise database 144 includes enterprise subscriber information, such as name, job title, electronic address information (e.g., telephone number, email address, instant messaging handle, direct dial extension, and the like), subscriber contact lists (e.g., contact name and electronic address information), other employee records, search results, and the like. In one configuration, the enterprise database 144 is configured in accordance with the Lightweight Directory Access Protocol.

Included in the memories of the communication server 136 (and/or located in one or more other network nodes on the external and/or internal networks 108 and 128) are tool(s) 172, call logs 198, contextual correlation engine 168, and token(s) 180. As will be appreciated, any or all of these modules or data can be located alternatively, partially, or in combination, within the internal network 128, in memories of the first, second, . . . pth computers 152a-p and/or of the first, second, . . . nth communication devices 156a-n and, within the external network 108, on one or more nodes. The contextual correlation engine 168, when centralized at the communication server 136, is applicable to multiple external and internal communication devices and computers. When the contextual correlation engine 168 is distributed in aggregate form among the various external and internal communication devices and computers and linked via a communication and control protocol.

Tool(s) 172 refer to any program that helps a user to complete a task or a set of tasks. Examples of tool(s) 172 include applications.

The contextual correlation engine 168 observes user behavior, detects trigger events, seamlessly generates and maintains tokens describing a workflow (e.g., a word processing session, a Web browsing session, a meeting, a customer or client servicing event, and the like), and/or uses tokens to recreate a workflow state. The contextual correlation engine 168, using the tokens 180, seeks to determine, launch, and/or otherwise access the information that a user will require for, and in advance of, a workflow task event. Although the contextual correlation engine 168 can perform these functions for a communication session, it is particularly advantageous for non-communication workflow sessions. For example, when a user has a task set by the personal information manager 148 the contextual correlation engine 168 launches automatically the related or referenced information for that task just prior to the start of the task on the user's calendar. Another example is when a user is doing work for a specific party in a contact management application the contextual correlation engine 168 launches automatically the referenced information for the task. The tokens 180 are maintained independently of how the referenced information is labeled, where it is stored, how it is accessed, and the like. In other words, the contextual correlation engine 168 is agnostic as to where the referenced information is stored; that is, the contextual correlation engine 168 simply follows the link in the token 180 and uses authentication information in the token to retrieve the referenced information. The referenced information can be displayed selectively on a graphical communication device, computer, or the like based on where the information is easiest to use, where the resident application is located, where the user prefers to see/use the information, or the like.

The contextual correlation engine 168 can use machine learning algorithms, such as through correlation, to monitor user behavior, offer to the user contextual and associative token creation suggestions when a variety of related materials are being used by the user, and/or predict simple patterns by the user to make the system more robust and accurate with less input from the user over time.

The contextual correlation engine 168 can contextually link what communication topics and applications, documents, files, sharepoints, web pages, blogs, micro-blogs, or other such materials are related to each other and create the necessary tokens to establish the relationships. For example, the contextual correlation engine 168 can contextually link communications, contact links, messages, prior communications, summary information, and the like to computer applications, documents, files, images, web pages, blogs, micro-blogs, Really Simple Syndication (“RSS”) feed, and other such information. To illustrate, e-mails, voice mails, and instant messages can be linked to one or more of an application, an electronic document, a file, a record, an image, a web page, a blog, a mico-blog, and/or an RSS feed. The contextual correlation engine 168 can use a variety of other detection/class-based indicators, such as rich presence information, activity information, persona, context information, user role, user level, and user organization, to make intelligent decisions about contextual association. The user can be an integral part of the contextual association process by using the system to generate tokens 180, make selections based on the decision mechanisms described herein, and the like.

This ability to make contextual linkages effectively bridges the traditional computer-telecom boundary with regard to work flow preparation. It acknowledges that the user does not care what domain that the materials were traditionally a part of and instead desires the ability to efficiently work on a project. Typically these work flow materials are being used in preparation for a future communication session, in response to a past communication session or will be distributed, reviewed, and/or discussed via a variety of collaborative communication sessions.

The contextual correlation engine 168 monitors user behavior over a variety of different communication devices and computers and correlates them with one another. Based on the monitoring, tokens 180 can be created and/or updated and forwarded to other communication devices or computers. Monitoring can avoid the necessity of needing to hot synchronize communication nodes so that they are up-to-date relative to one another.

The contextual correlation engine 168 can provide workflow materials to a newly added member of a work or task class or group. In other words, a common token is accessible to multiple users. An example is where the work flow is handled in a persistent session paradigm, such as Google™ Wave™.

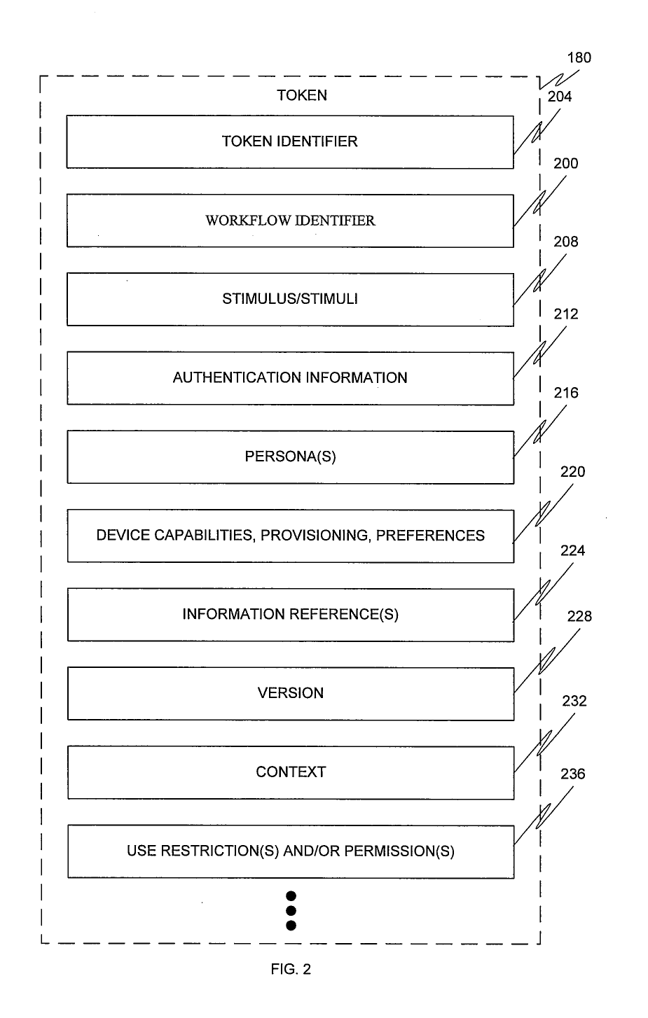

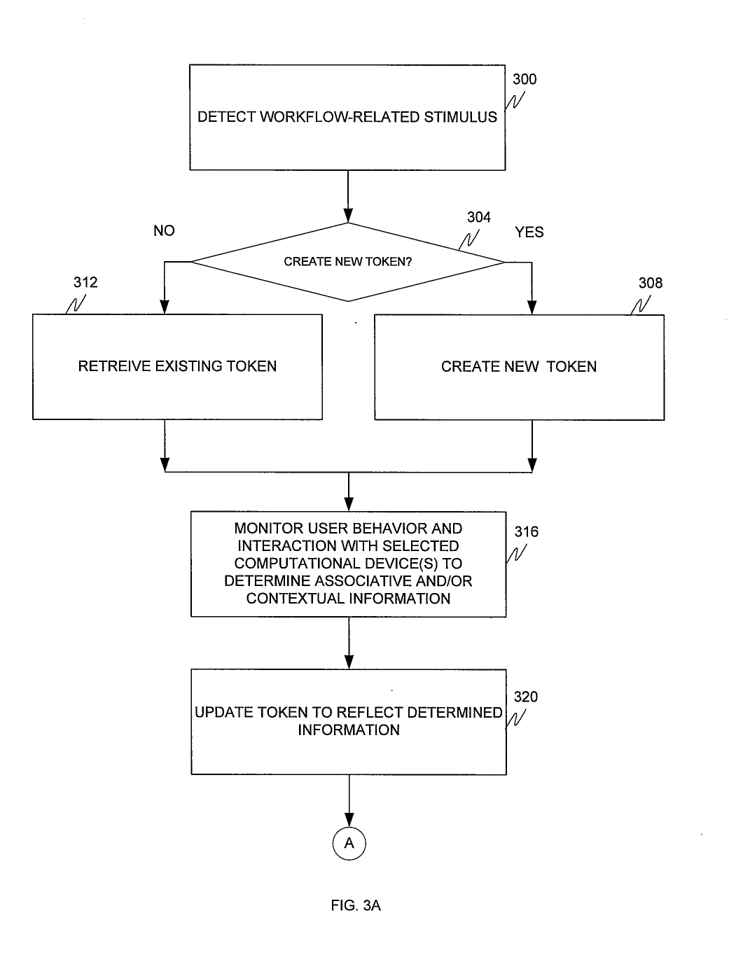

To better understand the capabilities of the contextual correlation engine 168, it is beneficial to discuss the contents of an illustrative token 180. Tokens 180 are portable containers of workflow information that capture workflow state and/or otherwise prepare a user to initiate and continue a workflow. With reference to FIG. 2, an illustrative token 180 includes a number of sets of information, including token identifier 204, workflow identifier 200, stimulus/stimuli 208, authentication information 212, persona(s) 216, device capabilities, provisioning, and preferences 220, information reference(s) 224, version 228, context 232, use restrictions and/or permissions 236, and the like.

The token identifier 204 can be any numeric, alphabetical, or alphanumeric identifier that identifies, uniquely, the token. Examples of token identifiers 204 include keywords, names, account numbers, communication or work session identifiers, employee identifiers, project names, team names, and the like. Token identifiers may be generated by a user or automatically. In one configuration, they are generated by a random or pseudorandom number generator.

The workflow identifier 200 refers to an associated workflow. The identifier 200 can be any numeric, alphabetical, or alphanumeric identifier that identifies uniquely the associated workflow(s). Examples of workflow identifiers 200 include keywords, names, account numbers, communication or work session identifiers, employee identifiers, project names, team names, and the like. Workflow identifiers 200 may be generated by a user or automatically. In one configuration, they are generated by a random or pseudorandom number generator. The workflow identifier 200 may or may not be the same identifier as is used for the token identifier 204.

The stimulus/stimuli 208 refer to the trigger, rules, policies, or conditions precedent to token activation or selection and optionally descriptive of the particular information reference(s) to be presented to the user when the token 180 is triggered. The simulus/stimuli 208 can reference or incorporate other information (data, policies, or rules) in the other parts of the token 180, including token identifier 204, persona(s) 216 (discussed below), device capabilities, provisioning, and preferences 220 (discussed below), information references 224 (discussed below), version 228 (discussed below), context 232 (discussed below), and use restriction(s) 236 (discussed below). Exemplary stimulus/stimuli 208 include token identifier receipt, workflow identifier receipt, electronic calendar entries associated with a task or workflow, party identity received from the user during a workflow (e.g., communication source or caller identity, communication recipient or callee identity, meeting participant identity, a task, role or other functional filter being active, a project management tool, an associated file, and events, critical paths and the like within such as project management tooltc.), cursor location during a workflow (e.g., cursor location in an electronic document, cursor location on a display, and the like), workflow-related subject, customer, or matter identifiers, file or record identifier or address (of a file of record related to the workflow or otherwise accessed as part of a workflow by a user), links accessed during a workflow, or other detected contextual identifiers or indicators.

Authentication information 212 refers to the information required to establish the validity of a transmission, message, or originator, to verify an individual's authorization to receive or access specific categories of information, or perform a specified task or operation, and/or to otherwise identify a user, data, or other entity. Examples of authentication information 212 includes credentials, such as usernames, log-in names, pins, and passwords, biometrics, digital certificates, security tokens, dongles, keys, social security numbers, driver license numbers, membership numbers, employee numbers, passport numbers, customer numbers, and other authentication and/or authorization attributes. The authentication information 212 is typically associated with the user, or person performing or initiating the workflow. The authentication information 212 enables the contextual correlation engine 168 to access content or information associated with information reference(s) 224 (discussed below). For example, the authentication information 212 can be a password to access a password-protected document or a log-in name and password to (re)initiate a session with an Internet site.

Persona(s) 216 refer to the various contextual profiles of the user and optionally rules or policies depending on persona(s) 216. For example, a user can have a “business profile” defined by business related information, such as employer name, the user's business-related electronic addresses (e.g., cellular phone number, desk phone number, e-mail address, instant message handle, and the like), satellite-based physical location coordinates associated with business location (current location can be determined, inter alia, by cellular phone location techniques), Web browsed URL's corresponding with business interests, times-of-day or days-of-week associated with business time, contact lists of business associates, clients, suppliers, customers, and/or other business-related contacts, and the like. The user can also have a “personal (non-business) profile” defined by personal information, such as family member names, the user's personal electronic addresses (e.g., cellular phone number, desk phone number, e-mail address, instant message handle, and the like), satellite-based physical location coordinates associated with personal (e.g., home or other residence) location, Web browsed URL's corresponding with personal interests, times-of-day or days-of-week associated with personal time, contact lists of friends, family members, hobby suppliers, charitable organizations and other volunteer activities, and/or other personal contacts, and the like. The optional rules or policies can stipulate, for a defined persona 216, what referenced information 224 (defined below) is to be presented to the user and/or on what device it is to be presented.

Device capabilities, provisioning, and preferences 220 refer to any set of communication node capabilities, provisioned features, and user preferences and rules or policies depending on such device capabilities, provisioning, and preferences 220. Device capabilities, provisioning, and preferences include, for example, screen size, CPUs, random access memory capacity, volatile memory capacity, nonvolatile memory capacity, total memory capacity, compatible and/or hosted communication applications, compatible and/or hosted communication clients, operating system, port configurations, wireless communication capabilities, compatible wired and wireless communication and data protocols, codecs, bandwidth, voice capabilities, video capabilities, text capabilities, Web capabilities, and screen aspect ration, icon positioning, data entry capabilities, removable storage, etc. The device capabilities, provisioning, and preferences 220 are descriptive of the particular information reference(s) to be presented on a selected communication node, where (on what device) it is to be presented, and how it is to be presented to the user when the token 180 is triggered. For example, first information is to be provided to the user when the user is on his or her cellular phone and second information to the user when the user is on his or her laptop computer. The first and second information is different but overlapping. In another example, the configuration or organization of the display of selected information depends on the capabilities, provisioning, and preferences 220 of the communication node currently in use by the user. For instance, when the user is on his laptop the particular size and arrangement of display elements (e.g., windows, icons, menus, indices, and caching) and user interface settings (e.g., volume setting, brightness setting, screen resolution, screen saver, wallpaper, and font size and type, and the like) depend on the capabilities, provisioning, and preferences of the laptop. When the user is on his cellular phone (which has different capabilities, provisioning, and preferences 220 than the laptop), a different size and arrangement of display elements and user interface settings are employed.

Information reference(s) 224 refer to electronic address, pointer, or link to content and other information associated with the token 180. The content and other information is retrieved when the stimulus/stimuli 208 is/are triggered. Examples of content and other information include software applications, electronic spreadsheets, electronic files, electronic records, electronic documents (e.g., word processing documents, prior meeting notes, and the like), web links, sharepoints, blogs, micro-blogs, Really Simple Syndication (“RSS”) feeds, single- and multi-media communications (e.g., voice mails, e-mails, instant messages, and the like), communications histories and other materials. In one configuration, the information reference(s) 224 are associated with the temporal state of or user location in a workflow.

The version 228 indicates a particular version of information reference(s) 224 to be presented to the user and/or rules or policies relating thereto. For example, the version 228 enables the contextual correlation engine 168 to determine which of many versions is to be presented to the user. In one configuration, the contextual correlation engine 168 monitors when multiple parties are working on the same version(s) of work flow materials, such as a document or file, and performs work flow material merges to ensure that subsequent work is done on a copy that possesses all of the relevant changes. This can be done with a combination of policies and rules having the ability to offer approval to those who contributed to the changes before the actual merge. Differentially, markings can be maintained or the changes accepted according to the policies and rules and the approval of contributors. Additionally, the version 228 enables the contextual correlation engine 168 to determine when one or more users of the documents do not possess all of the information required to effectively make their contribution to workflow. The contextual correlation engine 168 could determine where the additional information is located, seek approval from the owner, and subsequent to the approval offer it to another party or transfer a copy.

The context 232 refers to or defines the context of the user and, optionally for the user context, rules or policies dependent on contextual attributes. “Context” can be any indicator, attribute, or descriptor of a type and/or nature of an activity of a user, a role of a user, user level, a user persona, a circumstance of the user, a surrounding of the user, and an environment of the user. The contextual correlation engine 168 can use rich presence information, activity information, persona, context information, user role, user level, user organization, and a variety of other detection/class-based indicators to make intelligent decisions about contextual association. For example, context 232 defines various levels of urgency of the user's current tasks and includes various rules, each rule defining one of a plurality of contextual templates whether and how to interrupt the user. Each of the contextual templates describes circumstances associated with an urgency level of the user's current tasks. Assuming that a customer is attempting to contact the user, the context 232 could indicate, based on the identity of the customer and/or customer matter, that the user is only contactable by e-mail and not by instant messaging or voice call. In that event, the token 180 would instruct the communication server 136 how to respond to the customer query about the user's contactability (e.g., presence state, presentity, availability, etc.).

The use restriction(s) and/or permission(s) 236 refer to policy- or rule-based restriction(s) and/or permission(s) on presentation of referenced information based on a virtual or spatial location of the user, user role, level or persona, and/or the particular communication node currently in use by the user. For example, if the user is attempting to view business sensitive referenced information 224 in a public location, a use restriction would prevent or bar access to the information while the user is in the public location. In another example, if the user is attempting to view business sensitive information from his home computer, a use restriction would prevent or bar access to the information while the user is defined by his “at home” persona. In another example, a user permission would permit a plurality of members of a workgroup to use the token 180 to access referenced information. The permission(s) can be updated easily to extend the referenced materials to a newly added member of the class or group.

A workflow can correspond to multiple tokens 180, and a selected token 180 can correspond to multiple workflows. An example of the former relationship is where multiple tokens 180 are embedded or otherwise linked to various locations in a common document. When the user reaches each location, the respective token is triggered. An example of the latter relationship is where a token 180 created or configured by the user in a prior workflow is associated by the user with a subsequent, different workflow. The tokens 180 can exist independently of a workflow and be invoked automatically by monitoring user behavior or by receiving, from a user, a workflow identifier 200 or token identifier 204. The token 180 can be invoked by a user or contextual correlation engine 168 using the token identifier 204. Alternatively, it can be invoked or selected by the user via a drop down menu or other selection. Alternatively, the user or contextual correlation engine 168 can identify or select a particular workflow, thereby selecting automatically the workflow's associated tokens 180.

The tokens 180 can be unrelated or related in any suitable manner, such as hierarchically.

To illustrate the use of tokens 180, a number of examples will now be presented.

In one example, a user is drafting a report for a specified customer. In a prior report drafting workflow session, the user had multiple windows open, including not only a word processing window containing the report but also multiple Web browsing session windows providing search results presumably from the workflow and a blog window providing third party comments related to a subject of the report. When the prior workflow session ended, the contextual correlation engine 168 stored a token 180 defining not only the contents of each window (in the information references 224) but also (in the device capabilities, provisioning and preferences 220) the position of display elements, including the relative positions of the windows relative to one another. When the user requests, by the work processor, the report, the contextual correlation engine 168, using the authentication information 212, automatically launches links to the search results and to the blog and arranges the various display elements identically to the arrangement at the conclusion of the prior workflow session.

In another example, a user is scheduled to have an interoffice meeting with a team member. An entry for the meeting is scheduled on the user's calendar. The contextual correlation engine 168 identifies a keyword, such as a customer, client or matter number, in the entry description or alternatively references a workflow identifier 200 or token identifier 204 directly. A predetermined time before the meeting is scheduled to begin, the contextual correlation engine 168 identifies the workflow object or token 180 by a keyword in the workflow identifier 200 or token identifier 204 or associative link and accesses and displays the information referenced in the token 180. The windows are minimized until the time indicated in the user's electronic calendar that they will be used. In this way, the information is not disruptive of the work flow being handled in the prior time slot.

In another example, a user, in the course of a workflow, has a plurality of applications, documents, files, web links, sharepoints, blogs, micro-blogs, and communications open with regard to a specified task or party. The contextual correlation engine 168 records, periodically (e.g., at different times) during the course of the workflow session and by one or more tokens 180, the various applications, documents, files, web links, sharepoints, blogs, micro-blogs, and communications accessed or retrieved by the user, the order in which they are accessed, and the relative display element locations of the applications, documents, files, web links, sharepoints, blogs, micro-blogs, and communications. The contextual correlation engine, at the request of the user, creates and stores a series of tokens 180, each token 180 being associated with a specified temporal point or cursor location in the workflow session. The tokens 180 collectively form a template and can be linked to a master token 180 or a workflow object. The user invokes the template simply by referencing the master token 180 or workflow object. The various secondary or associated tokens 180 are retrieved and executed when the corresponding temporal point or cursor location is identified.

In yet another example, the contextual correlation engine 168 performs, automatically, corrections or updates to a draft document that is being worked on, simultaneously or sequentially, by several users. A first user working on the draft document makes a first set of changes while a second user makes a second different set of changes. The contextual correlation engine 168 reconciles the changes and creates a new version of the draft document (or master draft) incorporating the first and second sets of changes. When a third user requests the draft document, the contextual correlation engine 168 provides not the former version but the master draft document. Alternatively, the contextual correlation engine 168 can, when the third user attempts to retrieve the original draft document notify the user that the draft has previously been edited by the first and second users and permit the user to retrieve one or both of the fist and second edited drafts. Alternatively, the contextual correlation engine 168 can illustrate, by way of tokens 180 associated with differing locations in the original draft, to the third user in the original draft the respective first and second changes made by the first and second users. This approach can readily identify conflicting or inconsistent changes. If the third user currently has a non-business persona, the token 180 may prohibit showing the original draft or first and second sets of changes to the third user until the third user's persona changes to a business persona. The contextual correlation engine 168 can thus make sure that all parties working on a workflow have all of the materials in the correct versions necessary to contribute to the work. This is done, for instance, by the contextual correlation engine 168 comparing the contents, tokens, and versions that each member of the collaborative work flow is using.

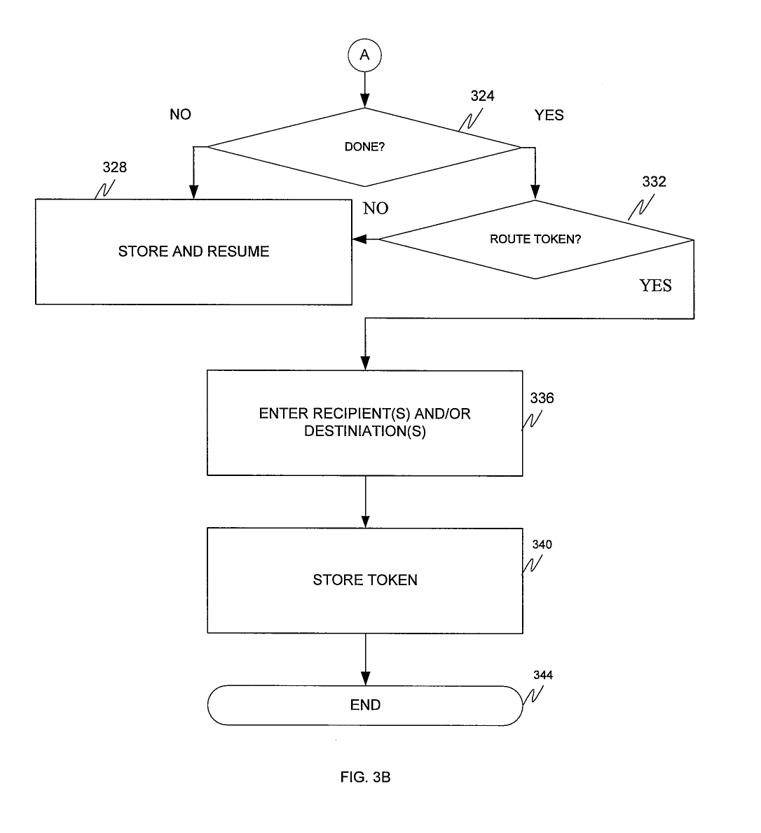

The operations of the contextual correlation engine 168 will now be described with reference to FIGS. 1, 3A, and 3B.

In step 300, the contextual correlation engine 168 detects a workflow-related stimulus. The stimulus, for instance, is a stimulus set forth in a token 180 container. The stimulus could be a selection of a workflow or token, such as by a drop down menu, by a user. The stimulus could be a selection, by the contextual correlation engine 168, of a workflow or token by monitoring user behavior. The stimulus could be a request by a user to create a new or update an existing workflow or token for a current work session.

In decision diamond 304, the contextual correlation engine 168 determines whether or not to create a new token 180 as part of a new or existing workflow. A new token 180 is created for a new workflow or a new part of an existing workflow. The user can, in response to queries by the contextual correlation engine 168, specify whether or not to create a token for a workflow for a future instance (or recurrence or continuation) of the workflow. When a new token 180 is to be created, the contextual correlation engine 168, in step 308, creates the new token 180. When a new token 180 is not required, the contextual correlation engine 168, in step 312, retrieves an existing token 180.

After performing either of steps 308 or 312, the contextual correlation engine 168, in step 316, monitors the user behavior and interaction with selected computational device(s) during the workflow to determine associative and/or contextual information. For example, if the user wishes to create a workflow and associated token(s), the user can request the contextual correlation engine 168 to monitor the user's operations, such as the sequence and contents of windows opened by the user. In that event, the contextual correlation engine 168 observes the user's interaction with tool(s) 172, enterprise database 144, personal information manager 148, social network(s) 124, Web search engines 130, Web accessible resources 132, and presence service 112.

In step 320, the contextual correlation engine 168 updates the token 180 to reflect determined information.

In step 324, the contextual correlation engine 168 determines whether the token or workflow is done. When the token or workflow is done, the contextual correlation engine 168, in decision diamond 332, determines whether or not the token 180 is to be routed to another computational device. If the token 180 is not to be routed or when the token or workflow is not done, the contextual correlation engine 168, in step 328, stores the token and resumes monitoring the workflow.

When the token 180 is to be routed, the contextual correlation engine 168, in step 336, either automatically or with user input, enters the recipient(s) and/or destination(s) and forwards the token 180 to electronic address(es) associated with computational nodes of the recipient(s). The recipient(s) could be other communication nodes or tool(s) of the user or of other parties. For example, the token can be linked to a future meeting (or calendar entry) involving the user. As noted, if the token 180 is exchanged between different first and second computational nodes having different capabilities, provisioning, and/or preferences the token 180 can, based on the device capabilities, provisioning, and preferences 220 in the token 180, vary what information and how information is presented on the two different computational nodes. By way of illustration and for a first token, a first communication node would retrieve different referenced information and display the referenced information differently compared to a second communication node having a different capability, provisioning, and/or user preference. Moreover, contextual correlation engines 168 in each of the computational nodes will be able to execute the contents of the token 180.

Finally, in step 340, the contextual correlation engine 168 stores the token 180, and, in step 344, terminates operation.

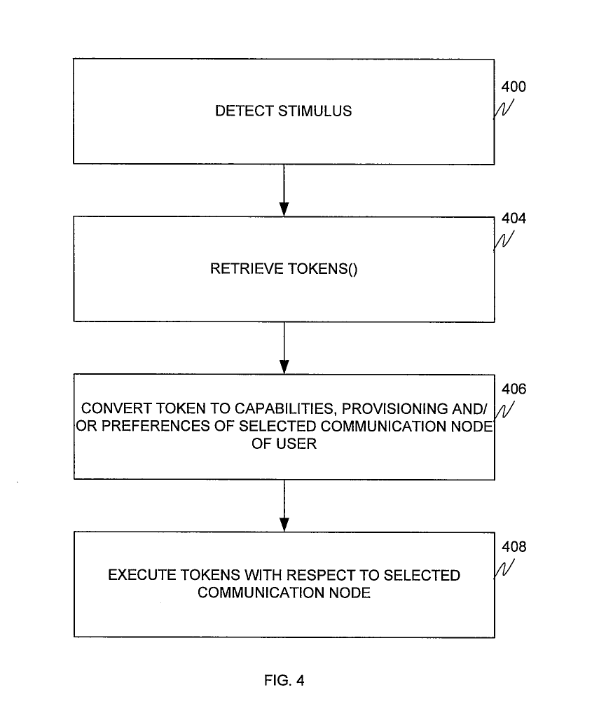

Another operation of the contextual correlation engine 168 will be discussed with reference to FIG. 4.

In step 400, the contextual correlation engine 168 detects a stimulus, such as a stimulus 208 in a token 180. The stimulus can also be initiation of a workflow.

In step 404, the contextual correlation engine 168 retrieves the token(s) 180 (or workflow object and associated tokens 180) associated with the stimulus.

In step 406, the contextual correlation engine 168 converts the token 180 to the capabilities, provisioning, and/or preferences of a selected communication node of the user. The conversion is discussed above in step 220.

In step 408, the contextual correlation engine 168 in the communication server 136 executes the retrieved token(s) 180 and provides the user with the referenced information for rendering to the user via the selected communication node. Alternatively, the token(s) 180 may be provided to the communication node and executed by the communication node. In that instance, the referenced information is requested by the communication node and, when received, rendered by the communication node to the user.

The exemplary systems and methods of this invention have been described in relation to a telecommunication system. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a communication server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

For example in one alternative embodiment, the systems and methods of this invention are implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
retrieving, by a processor executable contextual correlation engine and as part of a current and/or future instance of a noncommunication workflow, at least one token, the at least one token comprising at least one reference to information associated with the current and/or future instance of the workflow and being based on a prior instance of the workflow;
retrieving, by the processor executable contextual correlation engine and using the at least one reference, the information associated with the current and/or future instance of the workflow; and
displaying, by the processor executable contextual correlation engine and on a communication node of the user, the retrieved information.

2. The method of claim 1, wherein the at least one token is associated with the workflow, wherein the at least one token is retrieved in response to detection of at least one of a party identity and temporal event, wherein the at least one reference is to at least one of a prior communication, a message, a computer application, an electronic document, a file, a record, an image, a Web page, a blog, Really Simple Syndication (“RSS”) feed, and a micro-blog.

3. The method of claim 1, wherein the information associated with the workflow is retrieved in advance of a scheduled start time for the workflow, wherein the information associated with the workflow describes a state of the workflow at a prior point in time, and wherein the reference is a hyperlink to a Universal Resource Locator (“URL”).

4. The method of claim 1, wherein the user is associated with a plurality of communication nodes, wherein the at least one token specifies a subset of communication nodes of the user on which the retrieved information is to be displayed, and wherein the at least one token specifies how and where the retrieved information is to be displayed on the subset of communication nodes.

5. The method of claim 1, wherein the information associated with the workflow is retrieved in response to a detected location of a cursor during the workflow and wherein the reference is a hyperlink to a Universal Resource Locator (“URL”).

6. The method of claim 1, wherein the at least one token comprises authentication information needed to access the retrieved information and at least one of restrictions and permissions governing access to the retrieved information.

7. The method of claim 1, wherein the at least one token comprises contextual rules and/or polices controlling presentation of the retrieved information to the user based on a detected one of an activity of the user, a role of the user, a level of the user, a surrounding of the user, and an environment of the user.

8. A computer readable medium comprising processor-executable instructions to perform the steps of claim 1.

9. A system, comprising:
a processor executable contextual correlation engine operable, as part of a current and/or future instance of a workflow, to:
retrieve at least one token, the at least one token comprising at least one reference to information associated with the current and/or future instance of the workflow and based on a prior instance of the workflow;
retrieve, using the at least one reference, the information associated with the current and/or future instance of the workflow; and
display, on a communication node of the user, the retrieved information.

10. The system of claim 9, wherein the workflow is not a communication, wherein the at least one token is associated with the workflow, wherein the at least one token is retrieved in response to detection of at least one of a party identity and temporal event, wherein the at least one reference is to at least one of a prior communication, a message, a computer application, an electronic document, a file, a record, an image, a Web page, a blog, Really Simple Syndication (“RSS”) feed, and a micro-blog.

11. The system of claim 9, wherein the information associated with the workflow is retrieved in advance of a scheduled start time for the workflow, wherein the information associated with the workflow describes a state of the workflow at a prior point in time, and wherein the reference is a hyperlink to a Universal Resource Locator (“URL”).

12. The system of claim 9, wherein the user is associated with a plurality of communication nodes, wherein the at least one token specifies a subset of communication nodes of the user on which the retrieved information is to be displayed, and wherein the at least one token specifies how and where the retrieved information is to be displayed on the subset of communication nodes.

13. The system of claim 9, wherein the information associated with the workflow is retrieved in response to a detected location of a cursor during the workflow and wherein the reference is a hyperlink to a Universal Resource Locator (“URL”).

14. The system of claim 9, wherein the at least one token comprises authentication information needed to access the retrieved information and at least one of restrictions and permissions governing access to the retrieved information.

15. The system of claim 9, wherein the at least one token comprises contextual rules and/or polices controlling presentation of the retrieved information to the user based on a detected one of an activity of the user, a role of the user, a level of the user, a surrounding of the user, and an environment of the user.

16. A method, comprising:
monitoring, by a processor executable contextual correlation engine and during an instance of a workflow, at least one of behavior of a user and interaction of the user with a selected computational device to determine at least one of an association between the workflow information accessed during the workflow and a context of the user; and
updating a token associated with the workflow to reflect the at least one of an association between the workflow information accessed during the workflow and a context of the user, whereby the token describes a state of the workflow at a particular point in time.

17. The method of claim 16, wherein the at least one of behavior of a user and interaction of the user is user behavior, wherein the user behavior comprises accessing, by a link, the workflow information, wherein the token comprises the link to the workflow information, at least one stimulus for token activation, and a user credential to enable subsequent retrieval, by the link, of the referenced workflow information.

18. The method of claim 16, wherein the token comprises at least one reference to the workflow information and at least of a device capability, a device provisioning, and a device preference.

19. The method of claim 16, wherein the workflow information has a number of versions and wherein the token comprises at least one reference to the workflow information and at least one of a version of the workflow information, a restriction on presentation of the workflow information to the user, and a permission to present the workflow information to the user.

20. The method of claim 16, wherein the token comprises at least one reference to the workflow information and at least one of persona of the user and a context of the user.

21. The method of claim 16, wherein the contextual correlation engine monitors the at least one of the user behavior and user interaction on a plurality of communication nodes and correlates the monitored behavior in the token.

22. The method of claim 16, wherein the contextual correlation engine describes in the token any applications, electronic documents, electronic files, electronic records, web links, sharepoints, blogs, micro-blogs, and/or communications accessed by the user during the workflow, the order in which applications, electronic documents, electronic files, electronic records, web links, sharepoints, blogs, micro-blogs, and/or communications are accessed by the user during the workflow, and relative display element locations of any such applications, electronic documents, electronic files, electronic records, web links, sharepoints, blogs, micro-blogs, and/or communications.

23. The method of claim 16, further comprising:
sending the token to a communication node of a party other than the user.
